(19) United States
(12) Patent Application Publication
(10) Pub. No.: US 2010/0191602 A1
(43) Pub. Date: Jul. 29, 2010

(54) Mobile banking and payment platform

(76) Inventors: John Mikkelsen, Minneapolis, MN (US); Robert Freidson, St. Petersburg (RU); John P. Luther, Chicago, IL (US)

Correspondence Address: John P. Luther;Ladas & Parry LLP, Suite 1600, 224 South Michigan Ave.,, Chicago, IL, 60604, US

(21) Appl. No.: 12/653,550

(22) Filed: Dec. 15, 2009

Related U.S. Application Data
(63) Continuation-in-part of application No. 12/322,615, filed on Feb. 4, 2009.
Application No. 12/322,615 is a continuation of application No. 10/183,756, filed on Jun. 26, 2002, now Pat. No. 7,548,875.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.

(51) Int. Cl. G06Q 30/00; G06F 21/00; H04L 9/32; G06F 3/048; G06F 15/16; G06Q 40/00; H04W 4/12

(52) U.S. Cl. 705/14.64; 380/270; 713/182; 713/176; 715/810; 709/203; 705/35; 455/466

(57) ABSTRACT

To eliminate, or at least substantially eliminate, the security concerns of conventional Internet-enabled mobile banking operations, and mobile banking operations in general, the present invention provides perhaps the most secure mobile banking and payment or product/service purchase method extent which avoids security problems of the Internet and provides a rapid transfer of transactional information and other information as desired, inclusive of revenue generating advertisements with the architecture and techniques of the present inventive Internet data protocol (DTP).

### CROSS-REFERENCES TO RELATED APPLICATIONS

This is a continuation-in-part application claiming priority to U.S. patent application Ser. No. 12/322,615, filed Feb. 4, 2009, and U.S. patent application Ser. No. 12/322,618, filed Feb. 4, 2009, which are continuation and divisional applications, respectively, of U.S. patent application Ser. No. 10/183,756, filed Jun. 6, 2002, now U.S. Pat. No. 7,548,875, and which claims priority to U.S. Provisional Application Ser. No. 60/301,681, filed Jun. 27, 2001, U.S. Provisional Application Ser. No. 60/303,115, filed Jul. 3, 2001, U.S. Provisional Application Ser. No. 60/312,450, filed Aug. 14, 2001, and U.S. Provisional Application Ser. No. 60/343,159, filed Oct. 26, 2001, all of which applications are incorporated herein by reference.

### FIELD OF THE INVENTION

The present invention relates to novel banking methods, including a new protocol and venue for conventional banking usually conducted in person or over the Internet, and which may be performed remotely and wirelessly, and securely, over-the-air without the need for an Internet connection, and which may be conducted wirelessly (or by wireline) on an electronic device, such as a portable electronic device in the form of a cell phone device, or a wire line device as desired.

### BACKGROUND OF THE INVENTION

Mobile phones have become an integral part of the 21^{st} century landscape with an expected penetration of 4.5 billion by 2011. While North America and Europe have the highest penetration rate, reaching 100% in many Western countries, South America and Asia represent the fastest growing mobile markets.

In developing countries, the role of the mobile phone is more extensive than in developed countries, as it helps bridge the digital divide. Hundreds of millions of people, mainly in the developing world, have no access to banks because of remoteness and poor infrastructure. Yet many of these people have mobile phones. The mobile phone is the one device that people most often carry at all times, and mobile phone services beyond voice and text messaging are booming all over the globe. For example, people living in emerging markets or remote regions of Africa, South America and Asia who don't have a bank account or a computer still often own a mobile phone, which can provide them with access to basic financial services. Mobile phones represent a cost-effective solution for users, financial institutions and operators, allowing them to bridge the digital divide in places where traditional banking and Internet services are too expensive or simply nonexistent.

Easy access to financial services is widely acknowledged as highly desirable, in that users have ready and easy access to credit and can securely manage their money. Financial institutions can readily expand their user base and process more transactions. Governments also benefit from the effect credit has on lower-income sectors of the population and can better track funds distribution within their country.

Ubiquitous and versatile, wireless devices provide users weekly and around the clock access to financial services bringing the next market revolution-mobile banking, mobile payment, mobile wallet, mobile money transfer and other financial services to users anywhere and everywhere and at essentially anytime. Indeed, while the rate of Internet banking user growth has stabilized, mobile banking is spiking and recent market analyses predict that more than 800 million people will use the mobile services by 2011. Indeed, banks are fast moving into the mobile market, with many of the largest U.S. bank having already introduced some kind of mobile banking technology and with most if not all big (and many small banks) expected to have a mobile banking option in the near future. While in the U.S. only about 3% or so of the more than 50 million households that currently use online banking have also tried mobile banking, such is expected to grow to 30% by 2010, with such everyday functions as checking balances, monitoring recent transactions and paying bills and e-bills representing the bulk of activity, and with automatic purchase of goods and services with automatic payment options through banking channels representing a dramatically increasing industry. For example, while shopping at a department store or anywhere else, it would be extremely convenient to instantly check your debit card or credit card account for available funds and avoid those oftentimes unnecessary overdraft fees, and with a few operations on the phone a balance can be checked and/or money transferred from one account to another to cover any contemplated purchases. Other useful services can include locating the nearest ATM and banking centers, view transactions for checking and savings accounts, mortgages and home equity lines, including posted and pending transactions. Some examples of recent mobile banking methods and applications are described, for example, in U.S. Pat. Nos. 7,258,267 and 7,175,073.

The dramatic increase in mobile phone usage has also been followed by an ever increasing amount of mobile and/or Internet fraud, and although eager to use mobile financial services, many subscribers are correctly concerned about the security aspect when carrying out financial transactions over a mobile network. In fact, lack of security is seen as one of the biggest deterrents to the widespread adoption of mobile financial services or at least a major problem as mobile banking increases. Fraud prevention has become a pressing need across all modes of financial transactions.

Conventional mobile banking operations are usually conducted through an Internet connection. In spite of efforts to halt electronic fraud, the Internet has remained a notoriously dangerous place to do business. The impact of cybercrime is estimated to cause $100 billion in damages annually. All banks around the world fear a huge loss of reputation and dwindling customer confidence in their Internet platforms through very clever and increasingly successful Internet banking attacks. Furthermore, experts are now convinced that securing Internet banking through IT security methods (user authentication, encryption and authorization codes) is not enough, since almost every security system can be cracked in practice. It is well known that an unsecured wireless access point in the form of a router or broadband modem with wireless capability in an Internet connection is a dangerous weak link. Further, for example, a powerful new type of Internet attack has been seen as analogues to a telephone tap, except that it operates between computers and Web sites that are “trusted” by the computers. Such attacks prey on major problems with the way browsers interact with Secure Sockets Layer (SSL) certificates which is a common technology used in banking e-commerce and other sites that handle sensitive data.

The mobile banking and payment industry not being immune from pervasive Internet crime, personal identity and data kept on the mobile devices have previously been limited. The mobile phone has long been regarded as a device that is extremely personal and, as such, security on the handset has not had the same amount of attention as has been seen on the PC and fixed line internet. Indeed, many users are traumatized after a mobile-phone stocker targets them and a security threat to users and businesses is very real.

The environment in which mobile phones are used is rapidly changing and mobile devices are now ubiquitous to everyday functions of the mobile subscriber, both for personal and business use. However, the mobile phone being intrinsically linked with the mobile Internet has heightened the security risks associated with identity fraud.

With Internet security concerns like Trojans and malware migrating to the mobile phone, banks and other financial institutions are expected to use their experiences with such threats in online banking to help ensure the safety of this new mobile channel.

Some additional potential threats that can affect mobile banking and payment services include, for example, “cloning”, or copying the identity of one mobile phone to another, thereby allowing the perpetrator to masquerade as the victim, normally with the intent to have calls and other services billed to the victim's cellular account. In the case of mobile banking, cloning could provide a hacker access to the victim's financial accounts. Another potential threat is “hijacking”, in which an attacker takes control of a communication between two entities, masquerading as one of them. As with cloning, hijacking could provide a hacker access to the victim's financial accounts. Another potential threat is the use of a malicious code, or software in the form of a virus, worm or other “malware”, which is loaded onto the handset or a bank's server to perform an unauthorized process that will adverse impact on the confidentiality, integrity or availability of financial information and transactions. Malware, a contraction for “malicious software” that is inserted into a system usually covertly, is performed with the intent of compromising the confidentiality, integrity or availability of a victim's data, applications or operating system, or otherwise annoying or disrupting the victim. Yet another potential threat is known as the “Man-In-The-Middle” attack, which is an attack on the authentication protocol exchange in which the attacker positions himself between the claimant and verifier with the intent to intercept and alter data traveling between them. Still another potential threat may come in the form of “phishing”, or tricking a victim into disclosing sensitive personal information or downloading malware through an email. “Redirecting” is a threat by intercepting a communication by substituting a fraudulent address or identity, potentially by using a Man-In-The-Middle attack. FIG. 1 illustrates some vulnerabilities and attacks affecting Internet-based mobile payment systems.

It is not an exaggeration to state that one has to be paranoid while analyzing the security aspects of an m-banking and m-payment system based on wireless Internet connection.

It is well-known that any system is only as secure as the weakest link in the security chain. Given the pressure brought by regulatory agencies and consumers themselves, financial institutions are taking steps to bolster their lagging computer security. Nowadays most of financial institutions' own security platform is rather difficult to attack. As the result an army of Internet criminals have turned their attention to getting information directly from Internet enabled mobile customers themselves, as illustrated at FIG. 2.

The nature of the Internet as an open public network that allows for free exchange of information and files makes it inherently vulnerable to attack. Every time a customer connects to the Internet it faces potential danger of being open to hackers who could break into the system and cause damage. The TCP/IP protocols, the basis for today's Internet, lack even the most basic mechanisms for security. It was designed to operate in an environment where everyone was supposed to be able to communicate openly with everyone else. Consequently, TCP/IP has no security capabilities whatsoever and should be considered as the weakest link in the security chain.

Payments and banking are the biggest concern for mobile device manufacturers. At the same time, the manufacturers aren't installing additional security protection on the vast majority of the devices and generally will not allow consumers to install security software on mobile devices, such as is commonly done with PCs and laptops.

To safeguard against security risks, mobile users should use their device PIN codes, download mobile applications only from their financial institution, switch Bluetooth off when not in use, and avoid lending their phone to strangers to minimize the chance of someone downloading a malicious applications onto the device. However, oftentimes such safeguards are not enough.

### SUMMARY OF THE INVENTION

To eliminate, or at least substantially eliminate, the security concerns of conventional Internet-enabled mobile banking operations, and mobile banking operations in general, the present invention provides perhaps the most secure mobile banking and payment or product/service purchase method extent which avoids security problems of the Internet and provides a rapid transfer of transactional information and other information as desired, inclusive of revenue generating advertisements with the architecture and techniques of the Internet data protocol (DTP) described in U.S. Pat. No. 7,548,875, the entirety of which is incorporated herein by reference.

The invention is more fully disclosed in accordance with the following Detailed Description and accompanying drawings.

### BRIEF DESCRIPTION OF DRAWINGS

FIG. 1 illustrates vulnerabilities and attacks affecting Internet-based mobile banking and payment systems.

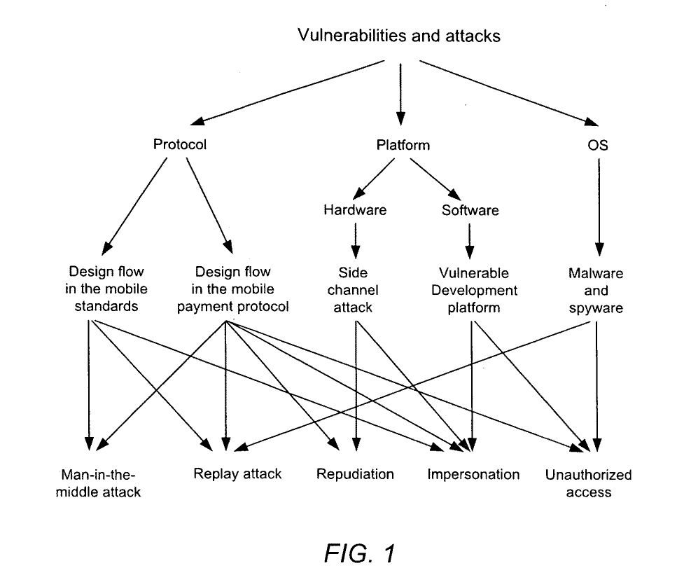

FIG. 2 illustrates the weakest link in the mobile banking and payment security chain.

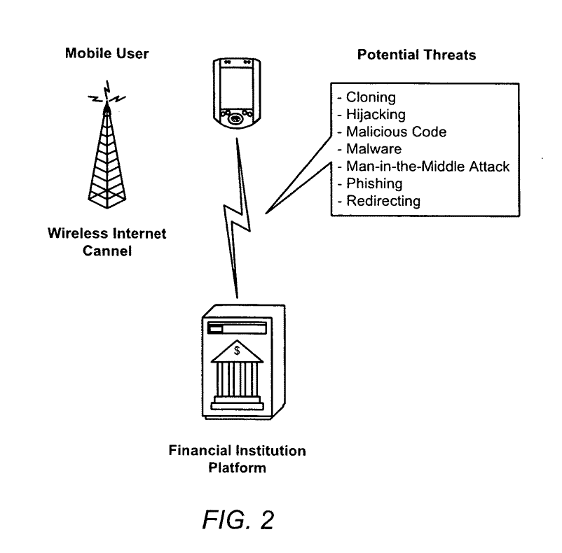

FIG. 3 illustrates non-Internet mobile banking and payment solution.

FIG. 4 is a general schematic diagram illustrating Mobile Banking Architecture.

FIG. 5 is a schematic diagram illustrating a high-level view of the protocols used to exchange messages between different components of Mobile Banking Platform.

FIG. 6 is a schematic diagram illustrating Network Configuration for distributed Mobile Banking Platform.

FIG. 7 illustrates the general architecture of the Interactive Alert Dialogue System.

FIG. 8 is a schematic of the data hiding and retrieval process.

FIG. 9 is a schematic diagram of the encoding system.

FIG. 10 is a schematic diagram of the decoding system.

FIG. 11 is a schematic diagram of a Mobile Payments System.

FIG. 12 is a schematic diagram illustrating Payment Network of a Mobile Payments System.

FIG. 13 is a schematic diagram illustrating typical steps of Purchase Process.

### DETAILED DESCRIPTION

### Non-internet Mobile Banking and Payment Platform

As mentioned above, the dramatic increase in mobile phone usage has been followed by an increase in mobile fraud, and although eager to use mobile financial services, many subscribers are concerned about the security aspect when carrying out financial transactions over the mobile network. In fact, lack of security is seen as the biggest deterrent to the widespread adoption of mobile financial services. As usage of the Internet and TCP/IP protocols increases in wireless environment, their lack of built-in security has become more and more problematic. The wireless Internet is now viewed by many businesses and organizations as a mission-critical asset whose unavailability leads to financial loss. Fraud prevention has become a pressing need across all modes of financial transactions.

The present invention has responded to these needs by developing the most secure Internet independent Mobile Banking and Payment solution based on non-Internet Data Transfer Protocol (DTP) methods systems and architecture described in U.S. Pat. No. 7,548,875.

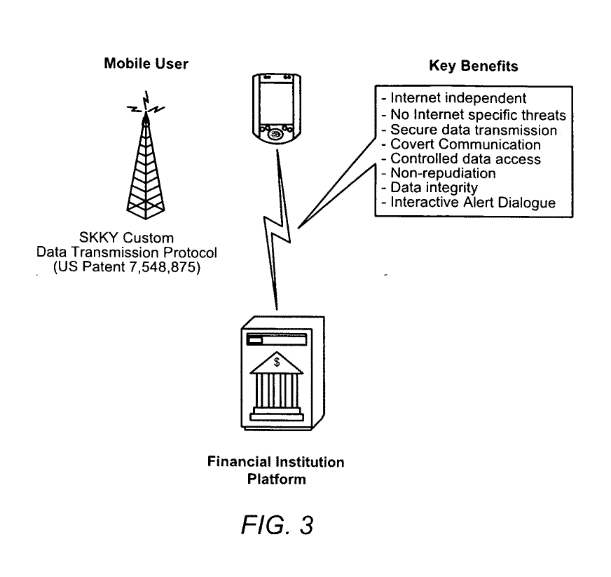

Key security benefits of the Mobile Banking and Payment solution are illustrated at FIG. 3, and described below.

### Security and Confidentiality of Information

The present inventive Mobile Banking and Payment Platform is a totally Internet independent system, and is consequently free of Internet fraud, identity theft and all other well-known Internet vulnerability described above. It provides end-to-end security and confidentiality of data by ciphering information for secure transfer over the mobile phone and wireless network to a financial institution or institutions of choice. In accordance with the invention, to obtain a high or perhaps the highest level of security, sensitive data, such as PIN and transaction details are never stored in the mobile phone. Some key aspects of the present invention as preferable embodiments are as follows:

### Cryptographic Operations

In the present method and system, all sensitive data is encrypted with double length 3DES (128 bit) keys. In addition, transactional security standards such as Derived Unique Key Per Transaction (DUKPT), short-lived transactional contexts and key roles are preferably used for added protection of financial transactions.

### Covert Communication

In addition to cryptographic operations all sensitive data is covert with data hiding methods which employ a secure steganographic algorithm based on FFT unitary transforms and quantization in the transform domain. By hiding secret data using a cover data as a wrapper, the existence of the information is concealed during transmission. In contrast to cryptography, which focuses on rendering messages unintelligible to any unauthorized persons who might intercept them, the essence of steganography lies in devising astute and undetectable methods of concealing messages themselves. Concealing the transmission of data automatically enhances its security since third parties will never realize that a communication has taken place.

### Data Integrity

Additionally, in accordance with the present invention, as data is digitally signed, any attempt to manipulate it will be detected because the signature will no longer correspond to the signed message.

### Non-repudiation

In the context of mobile banking and payment, non-repudiation refers to authenticating the customer and the financial institution participating in a financial transaction with high degree of certainty so that the parties cannot later deny having performed the transaction. To ensure non-repudiation, a proof must be generated to show that the transaction was performed by that party. The present Mobile Banking and Payment method and system addresses this requirement through the use of a user PIN known only to the user and protected by encryption, a transaction confirmation code sent by the financial institution, and a transaction log that records the details of every transaction.

### Interactive Alert Dialogue System

Traditional bank alert systems may be an effective customer service tool for fraud prevention, account management, bill payment and other banking functions. However most banks offering mobile alerts today are for the most part delivering one-way informational alerts notifying customers when a check clears, a statement is ready or a payroll deposit has occurred. Such informational alerts lack a response mechanism for the customer to instantly resolve issues or take action in extended conversations or workflow with bank a system.

To remedy this problem the present Banking and Payment Platform method and system preferably employs in another embodiment an Interactive Alert Dialogue System, which is highly effective response mechanism with 2-way messages dialogue between a Bank System and a customer. It provides a convenient way for customers to immediately resolve issues responding to alert messages with the “One Button” or “One-Click” principle capability.

The core architecture and technology of the present secure banking methods and system is an Alert Dialogue Server, as discussed in U.S. patent application Ser. No. 12/456,343, the entirety of which is incorporated herein by reference. Mobile dialogue system and mobile content delivery solutions, this system technology possesses the intelligence and capability to manage alert sessions and can correctly match each reply with a corresponding alert. For instance, if a consumer receives multiple actionable alerts but only replies to one, a server is able to track and determine which specific alert the customer is responding to. It offers a broad set of alert types that consumers can opt-in to receive to prevent fraud, ease account management and other transactions.

As a result, the present Mobile Banking and Payment Platform method and system provides a comprehensive set of financial services alongside full mobile banking and payment security features. Financial institutions can now offer their customers the freedom to manage their finances whenever and wherever they want, without being concerned about security and confidentiality issues.

### System Architecture

The present Mobile Banking and Payment Platform method and system includes a secure client application and a distributed servers' platform that provide secure access from a mobile phone to mobile banking, mobile payment and mobile money transfer services. The Platform is enabled in the mobile phone or other phone device and the like through a secure Client Application located in the end-user's phone. Secure transfers over the wireless network and financial transaction processing are managed by the Client Application and a distributed servers' platform, deployed at the payment service provider's site and at the financial institution.

### Mobile Banking System

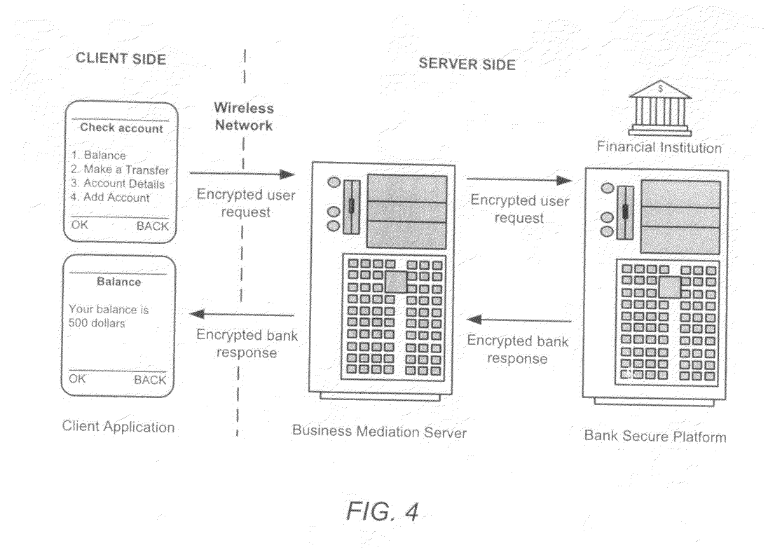

An example of Mobile Banking system may have Server-Client architecture illustrated at FIG. 4. The Client Side comprises the Client Application which may be installed on the client's phone memory or on the phone SD card, or on USIM/SIM card, and is effective to perform one or more of the following tasks: displaying appropriate menus processing user requests and responses; prompting the user for information and collected user input; generating transaction keys, ciphers sensitive information and signing data to be sent; sending and receiving transaction messages, optionally inclusive of product and/or service purchase information and description as to price and quantity; encrypting and decrypting sensitive information; and managing transaction security and confidentiality

The Server Side may comprise different modules performing system critical tasks. The main components of the server side are the Business Mediation Server and the Bank Secure Platform. The Business Mediation Server (BMS) ensures communications between mobile subscribers and financial institutions, and routes mobile banking transactions exchanged between the Client Application in the mobile user's phone and the Bank Secure Platform at the user's bank.

The BMS is effective to perform one or more of the following tasks: receiving subscribers' mobile banking requests, interprets them, formats and forwards the requests to the subscribers' bank for processing; maintains the status of the requests; logs transaction results for auditing and billing purposes; receives the bank's responses and sends them to the Client Application; and maintains the list of financial institutions available on that operator's services.

On the financial institution side, a Bank Secure Platform (BSP) performs transactions between mobile users and the bank's systems. More specifically, the BSP is effective to perform one or more of the following tasks: facilitates communication between bank systems and end-users; hosts response templates (pages); authenticates mobile customers; and ensures that financial transactions and customer data are secure

### Mobile Banking Platform Protocols and Transaction Flow

In accordance with this invention, the Client Application may use non-Internet Data Transfer Protocol (DTP) described in U.S. Pat. No. 7,548,875 or standard SMS messages protocol or a combination of thereof. It does not require a customer's cell phone to have wireless Internet connection.

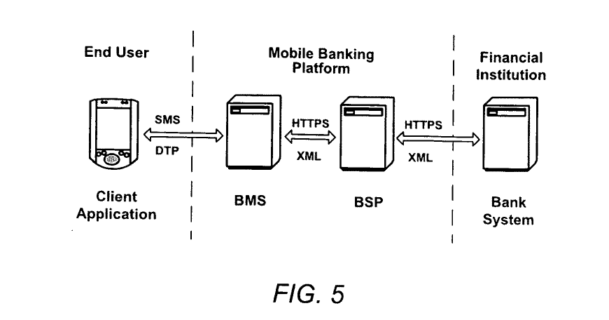

The server side of the present Mobile Banking Platform method and system components use standard protocols and interfaces to exchange information and to communicate with other network elements and bank systems, thus facilitating the integration of Mobile Banking into the existing infrastructure. A high-level view of the protocols used to exchange messages between difficult components of the Mobile Banking Platform method and system is illustrated in FIG. 5.

In one aspect of the invention, a mobile banking transaction is initiated by the mobile user or banking institution and is completed when the result is displayed on the user's phone or phone device. As a preferred example, but not intended to limit the invention to any particular communication flow process, the communication flow to process a user's request is as follows: The Client Application sends Mobile Banking requests using the present inventive non-Internet data transfer protocol (DTP) or SMS messages protocol or a combination of thereof; the BMS translates this request into HTTPS requests or on XML request; the BMS forwards the HTTPS requests to the BSP of the selected bank; the BSP provides for the cryptographic operations; the BSP communicates with the bank's systems, using a series of web services; the bank system responds; BSP ciphers the necessary information before proceeding; the BSP forwards and formats the response and the sends it to the BMS; and the BMS compiles the response and sends it to the Client Application using the present inventive non-Internet data transfer protocol (DTP) or SMS messages protocol or combination of thereof.

### Mobile Banking Network Configuration

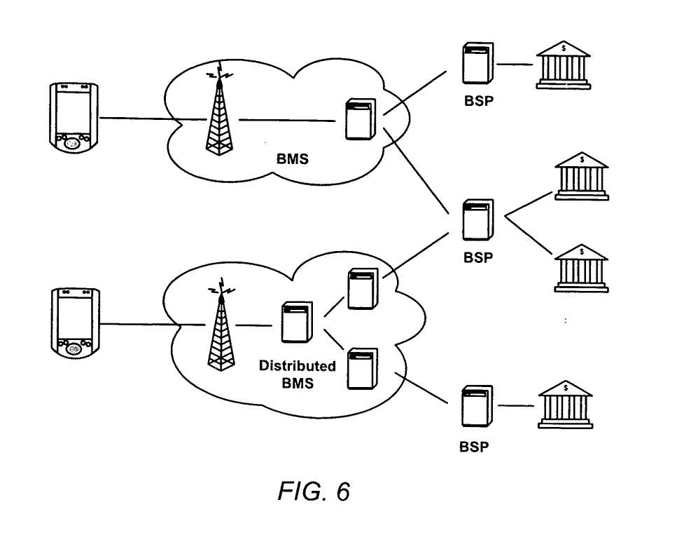

A preferred embodiment of a Network Configuration for distributed Mobile Banking Platform is illustrated in FIG. 6. With the present Mobile Banking Platform, a payment service provider can provide the service to subscribers that have bank accounts with different financial institutions. A bank can also choose to work with several operators, to provide mobile banking services to its customers, independently of their mobile service provider. It is also possible for several banks with light mobile banking traffic to share a Bank Secure Platform. The present Mobile Banking Platform is scalable through hardware clustering. To increase throughput, both BMS and BSP can (independently) be installed in clusters with a clustering engine distributing the traffic among several servers.

### Security and Confidentiality of Information

The Mobile Banking Platform provides end-to-end security and confidentiality of data by ciphering information in the Client Application for secure transfer over the mobile phone based on the present non-Internet Data Transfer Protocol or standard SMS messages protocol or a combination of thereof.

For the highest level of security, sensitive data, such as PIN and transaction details, are never stored in the client's cell phone or the Mobile Banking platform. All customer's and financial information is kept exclusively at a bank or some form of banking institution, entity or server(s), which also has the sole control over the cryptographic keys used to secure financial transactions. Users are required to identify themselves to a bank or entity with a Mobile Banking PIN that protects access to financial information and transactions. Secret keys only known to the client application and the bank are used to encrypt and sign transaction data, further proving the identity of the user.

All sensitive data is encrypted with double length 3DES (128 bit) keys. In addition, transactional security standards such as Derived Unique Key per Transaction (DUKPT), short-lived transactional contexts and key roles are used for added protection of financial transactions.

### Interactive Alert Dialogue System in Mobile Banking

An Alert System is particularly useful communication medium between wireless devices and bank system, which enabling banks to leverage the dynamic, real-time capabilities of the mobile banking system. This information can be highly personalized and can send alerts, for example, if an account balance is low, and a bill payment is due, or there is suspicious activity associated with one's credit card, debit card or other money transaction card, or personal or transactional information, or with any form of identity theft activity. Importantly, with proactive mobile banking, alerts are actionable.

Currently there are three levels of mobile alerts available to banks: informational, actionable, and interactive. Informational alerts enable low-cost delivery of messages to customers and reduce inbound calls to contact centers. Obviously, this is not very valuable for time-sensitive notifications such as low balance or fraudulent transaction alerts, especially when there is no response mechanism in place. With actionable alerts the customer can instantly address and resolve the issue by simply responding to the alert. As a result of this inherent response mechanism, actionable alerts are ideal for improved account management, innovative mobile payments and heightened fraud prevention. For example, if a potentially fraudulent transaction is detected, an actionable alert can be sent to the customer, who can instantly verify or dispute the transaction with a reply. Interactive Alerts take actionable alerts to the next level by enabling banks to have genuine, personalized and interactive mobile dialogue with the customer. For example, if no response is received to a bill payment alert, subsequent actionable alerts can be sent closer to the bill due date enabling payment via the mobile device but with added convenience or expedited payment fees. Interactive alerts may considerably increase the number of customer transactions by enabling both bank-to-customer and customer-to-bank interactions. It also offers a new way for banks to proactively take command of customer interactions by engaging with customers on a deeper, more personal level, which promotes customer loyalty and retention, reduces the cost of service, mitigates fraud and provides the opportunity for the bank to cross-sell products and services. For customers, interactive alerts provide the obvious comfort of being informed in real-time when issues arise with their financial accounts, and the convenience of being able to immediately resolve the problem via their mobile phone.

As one pertinent example, one may consider the instance of a questionable account activity. An interactive alert is immediately sent to the customer, asking him to verify the transaction by simply replying with a “Y” (for “yes”) or “N” (for “no”). The alternatives would be a phone call, email or informational alert, all of which require the customer to make an effort with the possibility of the customer's account being frozen until the transaction is verified.

For banks and other financial institutions, interactive alerts can significantly cut costs and generate new revenue. Banks can avoid huge losses from fraud and identity theft by utilizing interactive alerts as a fraud prevention tool. Interactive alerts also give banks the ability to generate revenue and serve as a direct marketing medium by enabling banks to accompany alerts with actionable, targeted and contextual offers.

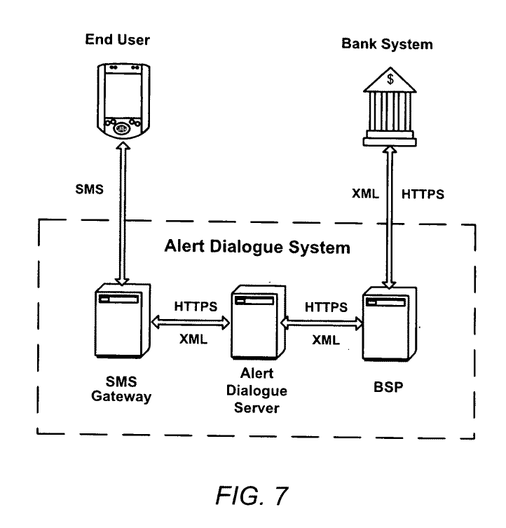

Interactive Alert Dialogue System includes the following main components: the SMS Gateway (SMSG), a Bank Secure Platform (BSP) and an Alert Dialogue Server (ADS). In one preferred non-limiting embodiment, the general architecture of the System is illustrated at FIG. 7, the SMS Gateway connects to an SMS Center (SMSC) of a mobile services operator, supports several SMSC protocols conversion of HTTP-requests to binary text messages, conversion of binary text messages to HTTP-requests, retries on failures and logging of transactions. The Alert Dialogue Server allocates a dialogue ID and channel to a dialogue with session details, matches of reply with corresponding dialogue and forwards of an answer back to BSP. If sending of answer fails, it is handed over to the spooler framework. The Bank Secure Platform (BSP) provides authentication, protective guards, such as load control, dynamic reply—URL management, XML message checking, delivery of dialogue status, etc.

### Alert Push Case Message Flow

In this aspect of the invention, or which this is merely one preferred embodiment a Bank System may send an XML-document as a send request using HTTP POST-method including recipient number and message contents, answer alternatives, and dialogue expiry time. A Bank Secure Platform (BSP) forwards the message to the Alert Dialogue Server if authentication and validation are successful and the load control permits. An Alert Dialogue Server performs the dialogue allocation based on the data in the XML-message and sender related parameters, assigns a dialogue ID and selects a free “channel” to be used in sending the message, stores the dialogue data, forms the SMS-message of the alternatives if the message is not marked to be pre-formatted, forwards the message to the SMS Gateway using a HTTP-request, and replies to BSP with a send result XML-message that contains dialogue ID for later answer-question matching. The SMS Gateway splits the message into smaller parts and sets the proper headers, and forwards parts to the mobile operator SMS Center (SMSC) for delivery to the End User.

### Reply Case Message Flow

In yet another aspect of the invention, in this non-limiting preferred embodiment, an End User sends a reply SMS with a one choice, one character (‘one button reply’) to the number where the original message came from. An SMS Gateway creates a HTTP-request with sender and recipient numbers and message content and sends it to the Alert Dialogue Server. An Alert Dialogue Server searches for an open dialogue with the same recipient and corresponding channel ID. If the dialogue is found, the dialogue status is updated and the HTTP-reply is sent to Bank Secure Platform (BSP). A Bank Secure Platform (BSP) fetches the reply URL of the dialogue from the database and sends the answer to it. If the sending is not successful it is retired after defined period.

The Interactive Alert Dialogue System implementation does not require any client software or end-user training; it works the same way on any mobile device, regardless of device type, platform, or operating system, and it is therefore capable of working with the hundreds of millions of mobile devices that are currently in use. This approach saves financial institutions significant costs in both product and human resource initiatives, and it offers customers an easy-to-use and nonintrusive method of authenticating to the bank.

The product includes capabilities such as an Actionable Alert functionality, which allows banks and financial institutions to deliver alerts for bill paying, antifraud notifications, important account change information, and so forth, empowering customers to take action immediately using SMS on their mobile phones. For example, banks can significantly reduce losses from fraud and identity theft by enabling customers to quickly respond to antifraud alerts from questionable account activities directly from their mobile phones.

The Interactive Alert Dialogue System employs standards-based components and protocols. This enables wide horizontal scalability across many different devices, protocols, carriers and applications.

### Covert Communication in Mobile Banking

Steganography or Stego literally means “covered writing”, which is derived from the Greek language. In contrast to Cryptography, where an adverse, or potentially adverse, party is allowed to detect, intercept and modify messages without being able to violate certain security premises guaranteed by a cryptosystem, the goal and capability of Steganography is to hide messages inside other harmless messages in a way that does not allow any adverse party to even detect that there is a second message present.

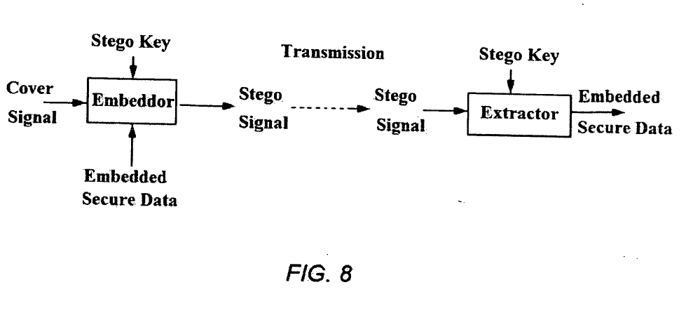

General principles of steganography are illustrated in FIG. 8. A data message is hidden within a cover signal in the block called embeddor using a stego key, which is a secret set of parameters of a known hiding algorithm. The output of the embeddor is called a stego signal. After transmission, recording, and other signal processing the embedded message is retrieved using the appropriate stego key in the block called an extractor.

Embedding information in audio signals, or audio steganography, is vital for secure covert transmission of information such as banking transactions via audio channels. On another level, watermarking of audio signals for digital rights management is becoming an increasingly important technique for preventing illegal copying, file sharing, etc.

### Data Hiding Method and Algorithm

This algorithm employed in accordance with the present invention is based on unitary transforms and quantization in the transform domain. The Fast Fourier Transform is selected when dealing with audio signals in the framework of the present non-Internet Data Transfer Protocol (DTP) described in U.S. Pat. No. 7,548,875.

The DTP protocol implements data transmission based on an OFDM modulation scheme, and a Fast Fourier Transform is already employed in the protocol sub-channel symbols from frequency to time area.

The algorithm for secure digital audio steganography employs unitary transforms with quantization in the transform domain. The secure data is embedded in the transform domain coefficients. The algorithm does not require the original signal or information about the secure content for detection. Only a few parameters are necessary for detection and extraction of the steganographic data. The algorithm features with a type of pseudorandom binary sequence (m-sequence) added to the cover signal for detection purposes. The framework of an algorithm includes characteristics of the human auditory system.

The Discrete Fourier Transform (DFT) of an N-point discrete-time signal x(n) is defined by

$$X ( k ) = {\sum }_{n = 0}^{N - 1} x ( n ) {W}_{N}^{kn} , \\ for K = 0 , 1 , … , N - 1$$

$$where {W}_{N} = {e}^{- j2 π / N}$$

Similarly, the Inverse Discrete Fourier Transform (IDFT) can be given by

$$x ( n ) = {\sum }_{k = 0}^{N - 1} X ( k ) {W}_{N}^{- kn} , \\ for n = 0 , 1 , … , N - 1$$

The coefficients appearing in DFT and IDFT structures are complex numbers with magnitude one of their inverses are complex conjugates of each other. A simple description of these equations is that the complex numbers X(k) represent the amplitude and phase of the different sinusoidal components of the input signal x(n). The DFT computes the X(k) from the x(n), while the IDFT shows how to compute the x(n) as a sum of sinusoidal components with frequency k/N cycles per sample.

The bin frequencies for an N point DFT are give by fs/N where fs is the sampling frequency. Among the N bins only N/4 bins are modified and the embedded information includes the pseudo random sequence and secure data.

Encoding process. Embeddor.

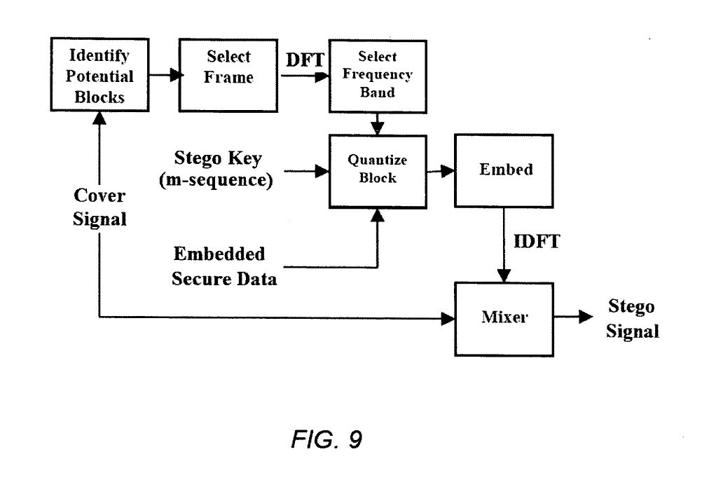

In another aspect of the invention a preferred non-limiting system block diagram for an encoding process useful in the present ivention is provided in FIG. 9. The basic encoding steps may be as follows:

Inputs: Cover audio signal, Embedded secure data.
Step 1: Find all potential embedding blocks in the time domain of the audio signal based on temporal masking characteristics;
Step 2: Generate the frequency spectrum of the selected block;
Step 3: Generate an m-sequence of suitable length (pseudo-noise binary sequence);
Step 4: Combine the m-sequence and the secure data create a new sequence;
Step 5: Select the best block in which we wish to embed the secured data. The frequency range of the band depends on frequency masking characteristics;
Step 6: Quantize the spectral content of the band;
Step 7: Quantize the new sequence and additively embed it into the cover;
Step 8: Take the Inverse Fourier Transform of the block;
Step 9: Replace the time domain block in the cover audio signal segment with the encoded block; and
Step 10: Repeat steps 3-9 for all blocks.

Output: Audio signal with embedded secure information (Stego Signal).

Decoding Process. Extractor.

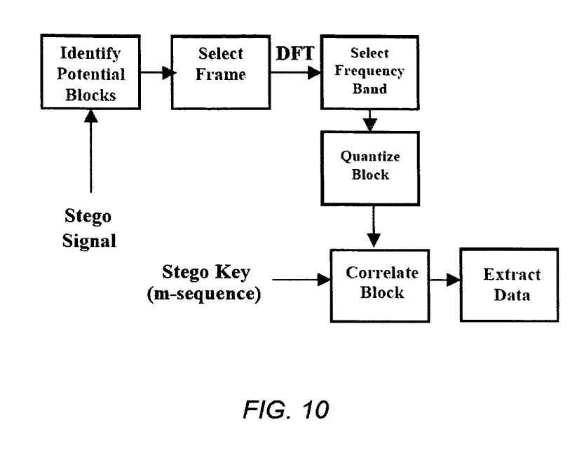

In yet another aspect of the invention, a preferred non-limiting system block diagram for the decoding block is provided in FIG. 10. The block size, temporal threshold value as a percentage of maximum amplitude, order of the m-sequence and the quantization step are fixed values and are available to the decoding block. The basic decoding steps may be as follows:

Input: Audio signal with embedded secure information (Stego Signal).
Step 1: Locate all potential blocks in the time domain of the audio signal based on threshold value. Obviously, these blocks are the same as the blocks located in the encoding process;
Step 2: Generate an m-sequence of give order. The generator polynomial is the same in the encoding and decoding block;
Step 3: Generate the frequency spectrum of the selected block;
Step 4: Quantize the block with the same quantization step;
Step 5: Correlate the block and the m-sequence obtained in step 2 to locate the starting point of the embedded band;
Step 6: Extract the embedded information; and
Step 7: Repeat steps 3-6 for the each of the blocks.

Output: Secure information.

Steganography and Cryptography are both intended to protect information from unwanted parties. Both Steganography and Cryptography are excellent means by which to accomplish this but neither technology alone is perfect and both can be broken. It is a preferred practice to use Cryptography and Steganography together.

Steganography is used along with cryptography, for example, if a message is encrypted using triple DES (EDE), which requires a 112 bit key, resulting in a message that has become quite secure as far as a cryptanalytic attack is concerned.

### Mobile Payment System

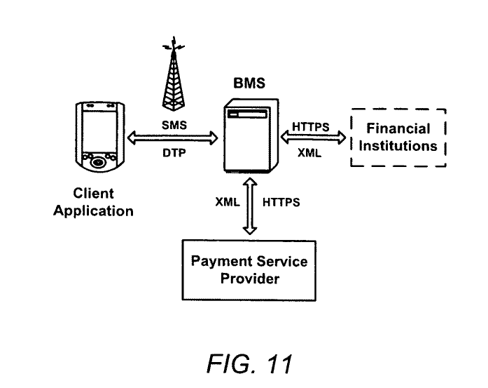

In yet another aspect of the invention, in another preferred non-limiting example, a secure and user-friendly solution for Mobile Payments System may be built on the base of the present Mobile Banking Platform as illustrated on FIG. 11. The entity that is operating the present Mobile Payments is a Payment Service Provider (PSP). It manages accounts for its customers, which includes both Buyers and Merchants. A typical PSP will have a billing system in place and will communicate with the Client Application in the mobile user's phone by a Business Mediation Server (BMS). The BMS ensures communication between mobile clients and PSP, and routes mobile payment transactions exchange between a Client Application in the mobile user's phone.

The main functions of the PSP may include one or more of the following: creation of accounts and assign terms for the accounts; connects accounts to customers; allow clients to access the accounts over secure channels; allows clients to query the account status; and issue Certified Payment Orders (CPOs) after requests made by customers. CPOs are similar to certified checks, accept deposits of CPOs, create routing tables for customers, and manage terms such as commissions and exchange rates.

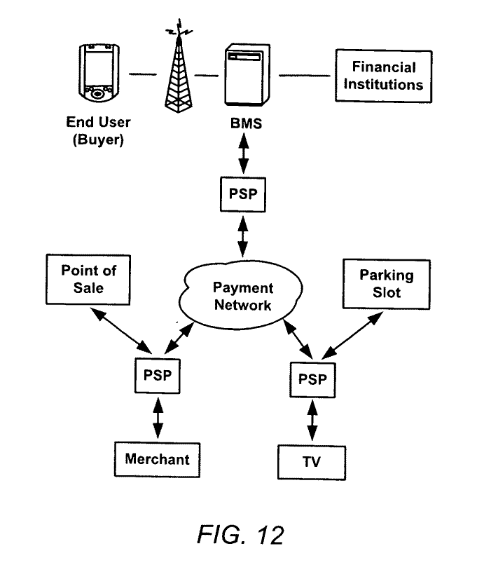

The Payment System facilitates multiple PSPs to interoperate, creating a Payment Network of PSPs, as illustrated in FIG. 12.

A PSP provides clients a “Routing Table”. This is a list of PSPs that can be “deposit targets”. Each entry in the list contains enough information to verify CPOs created by the target PSP. It also contains other details such as commissions, restrictions on sums and restrictions on deposit time frames. A Merchant will accept a CPO only if the routing table shows the existence of a “deposit chain”.

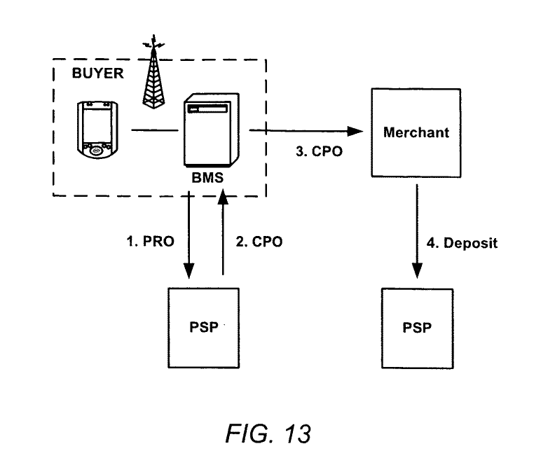

FIG. 13 illustrates in a non-limiting preferred embodiment an example of what may be typical steps of a purchase process in accordance with the present invention. The offered item and its price are presented to the Buyer may be as follows:
1. The Buyer decides that he wants to purchase an item. He/she sends via BMS a signed Request for Payment Order (RPO) to his or her PSP in order to create a Certified Payment Order (CPO) for the purchase. A CPO is similar to a certified check.
2. The Buyer's PSP creates a CPO. The CPO is issued to a specific Merchant although the Merchant ID does not necessarily have to appear in it. Each CPO has a unique global identifier to ease processing and it does not contain information about the goods that to be purchased.
3. The CPO is sent to a Merchant for the purchase.
4. The Merchant deposits the CPO with his PSP to collect the payment for the purchase.

The Payment System described above can be easily extended to other applications such as wireless P2P payments. It allows coexistence and interoperability of many Payment Service Providers and supports multiple financial models.

The System also allows a flexible commission strategy and supports the use of multiple currencies and currency conversion and flexible commission schemes.

The System uses industry standard tools and security mechanisms based on the present inventive DTP and open industry standards such as HTTPS, XML and RSA cryptography. All sensitive data is encrypted with double length 3Des (128 bit) keys. In addition, transactional security standards such as Derived Unique Key per Transaction (DUKPT), short-lived transactional contexts and key roles are used for added protection of financial transactions.

### Banking Phone Devices

While the present invention is contemplated for use with essentially any enabled phone or phone-type device or electric device with telephone capability, inclusive of both wireless and wireline capability, such as disclosed in U.S. Pat. No. 7,548,875, it is also contemplated that various banking and/or credit union or other entities may issue their personally branded cell phone or cell phone device for banking purposes in a similar manner as debit or bank cards are now issued under brand names or other logos, such as professional sports teams or collegiate teams or brands of automobiles etc. For example, as part of opening an account promotion, such branded devices could be issued fairly inexpensively free of charge, or perhaps for a nominal fee, or licensed, for example, to one or more vendors.

### Advertising Options

Also contemplated in this invention are various advertising methods employed in conjunction with banking methods and transactions. For example, when a mobile user is on hold on her cell phone during a banking transaction, or is intentionally put on hold for a predetermined time span, instead of conventional hold music playing, the mobile user will receive an audio and/or visual advertisement push to their phone or advertising content of any kind or a clip of a TV show, and the like. This replaces the conventional “hold music” used by many large companies and other entities and increases the value of sending an advertisement during this “dead use time,” for both advertiser and consumer alike. Additionally, it is also contemplated that when an alert is activated, or when a service operator or callee comes on the line, such will break into any advertisement being played and alert the user that someone or something or other content is coming on the line such that the user on hold does not miss the alert or proposed call, such as with a service operator.

Also contemplated is advertising content in the form of mortgages, car/house loans, insurance packages and whatever else, even advertising about new cars etc, or essentially anything, for example, they can be purchased with a bank loan, or credit union or advance, or advance from a line of credit or equity loan. Banks up to the present time have traditionally not really had an effective venue to reap significant revenue from advertising. and certainly not a great deal from television. The present invention presents via mobile screen devices, and telephone screen devices in general, possible huge revenue streams for banks via the shear enormous amount of everyday transactions where users would be exposed to advertisements, such as in the corner or other portion of a cell phone screen. These advertisements may also be interactive impulse purchase advertisements, as where a user has already got their finger on their money account in the cell phone push button array, such as in a money transfer, and decides to purchase something in the advertisement at the same time, while checking their account or transferring money.

While the present invention has been particularly described in conjunction with several preferred embodiments, it is evident that many alternatives, modifications and variations will be apparent to those skilled in the art in light of the forgoing description. It is therefore contemplated that the appended claims will embrace any such alternatives, modifications and variations as falling within the true scope and spirit of the present invention.

What is claimed is:

1. A wireless banking system comprising:
a mobile phone device for conducting wireless banking transactions and activities with a server system of a bank, credit union or other savings institution through a wireless communication network, wherein
said phone device comprises a digital signal processor, and optionally two or more processors inclusive of a digital signal processor, and wherein information in the form of a transaction and/or activities is concealed during transaction to and from the mobile phone.

2. The system of claim 1 further comprising cryptographic means.

3. The system of claim 2 further comprising covert data hiding means.

4. The system of claim 3 wherein said covert data hiding means comprises a secure steganographic algorithm means.

5. The system of claim 1 wherein data is digitally signed.

6. The system of claim 1 further comprising a user PIN, a transaction confirmation code and a transaction log.

7. The system of claim 1 further comprising a two-way message dialogue means between a bank system and user, and effective for a user or banking institution to resolve isues in response to any alert message or messages with one or more key strokes of a telephone push button array.

8. The system of claim 7 wherein in response to multiple alerts, a user may specifically and detectably respond to a specific alert.

9. The system of claim 1 wherein said mobile phone comprises a secure client application means effective for one or more of the following: displaying menus; processing user requests and responses; prompting a user for information and collected user input; generating transaction keys; ciphering information and signing data; sending and receiving transaction messages, optionally inclusive of product and/or service purchase information and description as to price and quantity; encrypting and decrypting information and managing transaction security and confidentiality.

10. The system of claim 9 further comprising one or more servers effective for enabling communications between mobile users and financial institutions and for routing mobile banking transactions and/or activities exchanged between a client application in a mobile user's phone and bank secure platform means at a user's bank.

11. The system of claim 10 wherein the server is effective for one or more of the following functions: to receive a user's mobile banking requests; interpret said requests; format and forward said requests to a user's bank for processing; maintaining the status of requests; logging transactions results or auditing and billing purposes; receiving a bank's responses and for sending same to the client application means; and maintaining a list of financial institutions available with respect to the user's services.

12. The system of claim 11 further comprising a bank secure platform means effective to perform transactions between mobile users and a bank or bank type system, and further effective to performing one or more of the following tasks: facilitating communication between bank systems and end-users; hosting response templates and pages; authenticating mobile customers; and ensuring the security of financial transactions and customer data.

13. The system of claim 9 wherein said client application means employs a non-Internet algorithmically compressed data transmission or SMS text message or a combination thereof.

14. The system of claim 1 further comprising a communication flow to process a user's request, and which comprises the following steps: the client application sends a mobile banking request using non-Internet data transfer protocol comprising transmission of compressed digital content(DTP) or SMS messages protocol or a combination of thereof to a server; the BMS at the server translates this request into HTTPS requests or an XML request; the BMS forwards the HTTPS requests to the BSP of the selected bank; the BSP provides for the cryptographic operations; the BSP communicates with the bank's systems, using a series of web services; the bank system responds; BSP ciphers the necessary information before proceeding; the BSP forwards and formats the response and then sends it to the BMS; and the BMS compiles the response and sends it to the client application using the non-Internet data transfer protocol (DTP) comprising transmission of compressed digital content or SMS messages protocol or combination of thereof.

15. The system of claim 1 further comprising a network configuration comprising a payment service provider effective to service users having bank accounts with different financial institutions and/or to service more than one financial institution simultaneously, or at different times and/or to service users' in banking operations and transactions independent of users' mobile service provider.

16. The system of claim 1 which is securable through mobile clustering.

17. The system of claim 9 wherein information and/or data is secured by ciphering information in the client application.

18. The system of claim 1 wherein data, personal information and transaction details and financial information is stored exclusively at a bank or banking institution's server or servers which has exclusive control over cryptographic means effective to secure financial information, personal information and transactions.

19. The system of claim 18 further comprising secret means known only to the client application and the bank or banking institution and are effective to encrypt and sign application data.

20. The system of claim 19 wherein data, financial and personal information and transactions comprise encryption with double length 3DES (128 bit) keys, and optionally comprise one or more transactional security standards selected from Derived Unique Key per Transaction (DUKPT), short-lived transactional contexts and key roles.

21. The system of claim 8 wherein said alert is effective to signify one or more of a low account balance or account balance magnitude, that a bill payment or other payment is due, and/or that there is an indication of suspicious activity associated with a credit or debit card or other transaction card, or personal or transactional information, or with any form of identity theft activity.

22. The system of claim 21 wherein the alert is one or more of informational, actionable, and interactive.

23. The system of claim 22 further comprising an interactive alert dialogue system means comprising one or more of the following: an SMS Gateway (SMSG), a Bank Secure Platform means (BSP), and an Alert Dialogue Server means (ADS).

24. The system of claim 23 further comprising a spooler framework.

25. The system of claim 23 wherein the SMS Gateway is in communication with the SMS (SMSC) center of a mobile services operator and is effective to support one or more SMSC protocols conversion of HTTP-requests to binary text messages; conversion of binary text messages to HTTP-requests; retrial of conversion on failures and logging of transactions.

26. The system of claim 23 wherein the alert dialogue server is effective to perform one or more or allocation of dialogue ID and channel to a dialogue with session details matches of reply with corresponding dialogue and forwarding of an answer to BSP means.

27. The system of claim 25 wherein the BSP means is effective to provide one or more of authentication, protective guards, load control, dynamic reply-URL management, XML message checking and delivery of dialogue status.

28. The system of claim 1 comprising a hiding algorithm means effective to embed information and an extractor means to retrieve embedded information.

29. The system of claim 28 wherein the hiding algorithm means is effective for secure digital audio steganography.

30. The system of claim 1 comprising one or more phone devices which are issued with identifying brands and/or logos or trade dress or trademarks from a banking institution or similar institution.

31. The system of claim 1 wherein at any point during an operation employing a phone device an advertisement in the form of visual or audio content is displayed on a cell phone screen.
